(19) United States
(12) Patent Application Publication
(10) Pub. No.: US 2012/0065801 A1
(43) Pub. Date: Mar. 15, 2012

(54) METHOD AND SYSTEM FOR CONTROLLING A BUILDING LOAD IN TANDEM WITH A REPLENISHABLE ENERGY SOURCE IN ORDER TO INCREASE THE APPARENT SIZE OF THE REPLENISHABLE ENERGY SOURCE

(75) Inventors: John Rossi, Norcross, GA (US); David Ellis, Norcross, GA (US)

(73) Assignee: COMVERGE, INC., Norcross, GA (US)

(21) Appl. No.: 13/229,739

(22) Filed: Sep. 11, 2011

Related U.S. Application Data
(60) Provisional application No. 61/381,515, filed on Sep. 10, 2010.

(51) Int. Cl. G06F 1/26

(52) U.S. Cl. 700/295; 700/297

(57) ABSTRACT

A method and system for controlling a building load in tandem with a replenishable energy source includes generating a control signal comprising at least one of a source command and a sink command. The control signal is transmitted over a communications network to a replenishable energy storage controller. Next, a capacity of the replenishable energy source is determined in response to the control signal. Then a capacity of the building load is determined in relation to the capacity of the replenishable energy source. After this determination, the building load is used as one of a source for supplying energy and a sink for receiving energy in response to the control signal. The replenishable energy source may also be used as a source for supplying energy or a sink for receiving energy in response to the command signal.

### PRIORITY AND RELATED APPLICATIONS STATEMENT

This application claims priority under 35 U.S.C. §119(e) to provisional patent application Ser. No. 61/381,515 filed on Sep. 10, 2010, entitled, “A METHOD AND SYSTEM FOR CONTROLLING A BUILDING LOAD IN TANDEM WITH A REPLENISHABLE ENERGY SOURCE IN ORDER TO MULTIPLY THE APPARENT SIZE OF THE REPLENISHABLE ENERGY SOURCE,” the entire contents of which are hereby incorporated by reference.

### BACKGROUND

The electric grid is a complex interconnection of generators supplying energy to loads. Since, in general, it is not feasible to store large amounts of energy, the generation supply must be constantly varied to match the presented load. To accomplish this balance, grid operators who coordinate electricity supply in several geographic regions (such as several States in the United States, like Pennsylvania, New Jersey, and Maryland which may service the mid-Atlantic regions and parts of the mid-West) deploy various services that help to maintain this balance.

These various services deployed to maintain this balance have been generically characterized as ancillary services. Such ancillary services usually include Frequency Regulation. Frequency Regulation relates to the frequency of electrical current in the grid. If the electrical demand in the electric grid exceeds electrical power generation, then generators in the United States are slowed to below 60 Hz. If power generation in the United State exceeds the electrical load on the grid, then the generator frequency may rise above 60 Hz.

As the aforementioned example demonstrates, balancing generation with load and maintaining the system frequency of the electrical at approximately 60 Hz (for systems in the United States, 50 Hz for other countries like Europe) requires system operators to adjust the output of power generators up or down to match the load. This change in generator output is controlled by a signal to the generator that commands it to increase or decrease output. This signal is usually updated at an exemplary rate of every approximately two to approximately four seconds.

While this system of balancing generation output with electrical load may be effective, it can be taxing on generators and inefficient. Ramping a generator up and down is less efficient than operating a generator at a set operating point. Protection circuits are usually employed to protect generators when there is a need for a frequency shift. Also, due to inertia in generators, they are generally incapable of adapting instantaneously for changing their frequency output in response to commands. Accordingly, what is needed in the art is a device or system that may compensate for excess energy generation and that may compensate for reduced energy generation without taxing or requiring generators to change their output.

### SUMMARY

A method and system for controlling a building load in tandem with a replenishable energy source includes receiving a control signal comprising at least one of a source command and a sink command. The control signal is transmitted over a communications network to a replenishable energy storage controller. Next, a capacity of the replenishable energy source is determined in response to the control signal. Then a capacity of the building load is determined in relation to the capacity of the replenishable energy source. After this determination, the building load is used as one of a source for supplying energy and a sink for receiving energy in response to the control signal. The replenishable energy source may be used as a source for energy in response to a source command signal in which the replenishable energy source supplies electrical energy to an electrical energy distribution system. The replenishable energy source may be used as a sink for receiving energy in response to a source command signal in which the replenishable energy source receives electrical energy from an electrical energy distribution system. The replenishable energy source may include at least one of a battery, a capacitor, and a combination of a battery and a capacitor, and/or other energy storage devices. Meanwhile, the building load may include at least one of a digital lighting ballast; heating, ventilating, air-conditioning (HVAC) equipment; a water heater; an arc furnace; an electric motor; and a piece of industrial production equipment.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all Figures.

FIG. 1 is a diagram of a system for controlling a building load in tandem with a replenishable energy source in order to increase the apparent size of the replenishable energy source;

FIG. 2 is diagram that illustrates a capacity for an exemplary energy storage device ;

FIG. 3A is a diagram illustrating exemplary details of an energy storage controller, a building load controller, an energy storage device, and building loads illustrated in FIG. 1;

FIG. 3B is a diagram illustrating exemplary details of an energy storage controller, a building load controller, an energy storage device, and building loads illustrated in FIG. 1 according to one exemplary embodiment;

FIG. 3C is a diagram illustrating exemplary details of an energy storage controller, a building load controller, an energy storage device, and building loads illustrated in FIG. 1 according to one exemplary embodiment;

FIG. 4 is a diagram of the main components for an exemplary energy storage controller 5 illustrated in FIG. 1; and

FIG. 5 is a flowchart illustrating a method for controlling a building load in tandem with a replenishable energy source in order to increase the apparent size of the replenishable energy source.

### DETAILED DESCRIPTION OF EXEMPLARY EMBODIMENTS

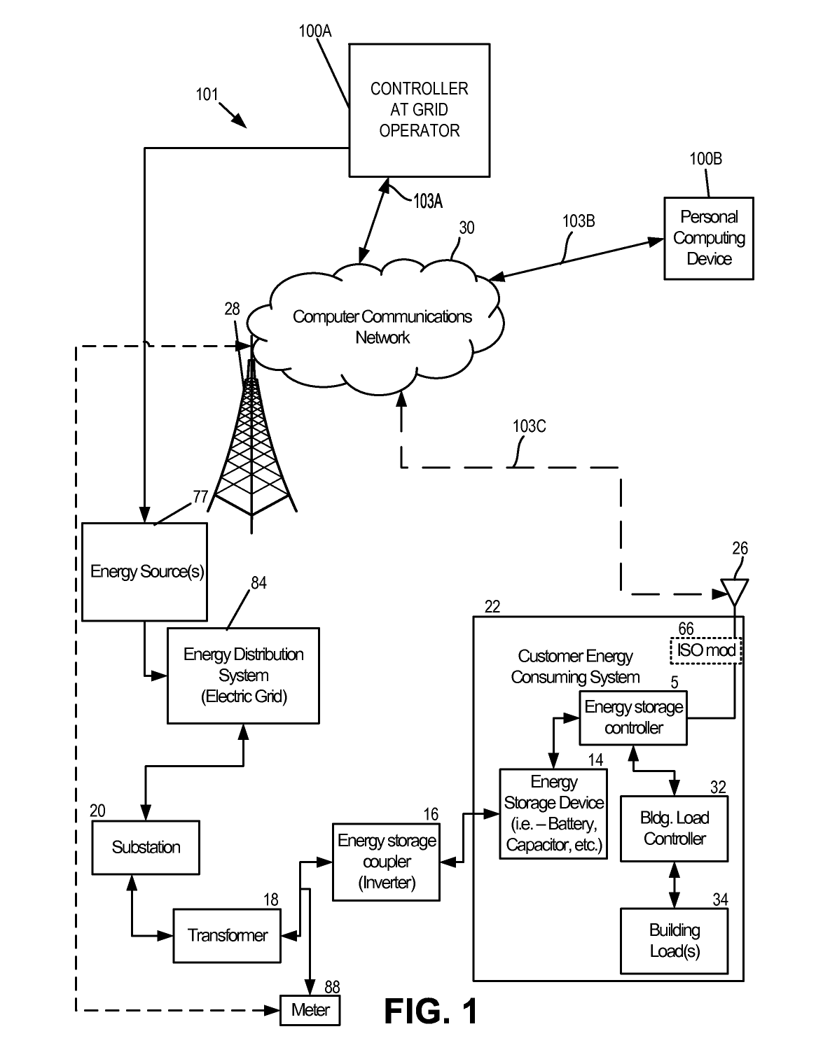

Referring initially to FIG. 1, this figure is a diagram of a system 101 for controlling a building load 34 in tandem with a replenishable energy source 14 in order to increase the apparent size of the replenishable energy source 14. The system 101 may include a customer energy consuming system 22, an energy storage coupler 16, a wireless communications tower 28, a communications network 30, one or more energy sources 77, an energy distribution system 84, a substation 20, a transformer 18, a controller 100A at a utility provider, and a personal computing device 100B.

Exemplary wireless communication networks 30 that may employ wireless communications towers 28 or wireless environments in general include, but are not limited to, Advanced Metering Infrastructure (AMI) networks, Home Area Networks (HANs), any combination of the above, and other similar wireless communication networks. Many of the system elements illustrated in FIG. 1 are coupled via communications links 103A-C to the communications network 30.

The links 103 illustrated in FIG. 1 may comprise wired or wireless communication links. Wireless communication links include, but are not limited to, radio-frequency (“RF”) links, infrared links, acoustic links, and other wireless mediums. The communications network 30 may comprise a wide area network (“WAN”), a local area network (“LAN”), the Internet, a Public Switched Telephony Network (“PSTN”), a power lines communication (“PLC”) network, a paging network, or a combination thereof.

The communications network 30 may be established by broadcast RF transceiver towers 28. However, one of ordinary skill in the art recognizes that other types of communication devices besides broadcast RF transceiver towers 28 are included within the scope of the system 101 for establishing the communications network 30.

The controller 100A at the utility provider or grid operator may comprise a computer server. The controller 100A may issue commands that include load control parameters which are sent over the communications network 30 to the customer energy consuming system 22. Such load control parameters may include, but are not limited to, commands for the replenishable energy source 14 to function either as a source or a sink. A term for such control signals as understood by one of ordinary skill in the art as of this writing is area control error (ACE) signals. ACE signals may be updated from about every four seconds. Such signals instruct participating resources to source or sink a specified amount of energy.

When a replenishable energy source 14 functions as a source, it provides power in an upstream manner towards the energy distribution system 84 and the energy sources 77. When the replenishable energy source 14 functions as a sink, it receives excess energy from the energy sources 77 and the energy distribution system 84.

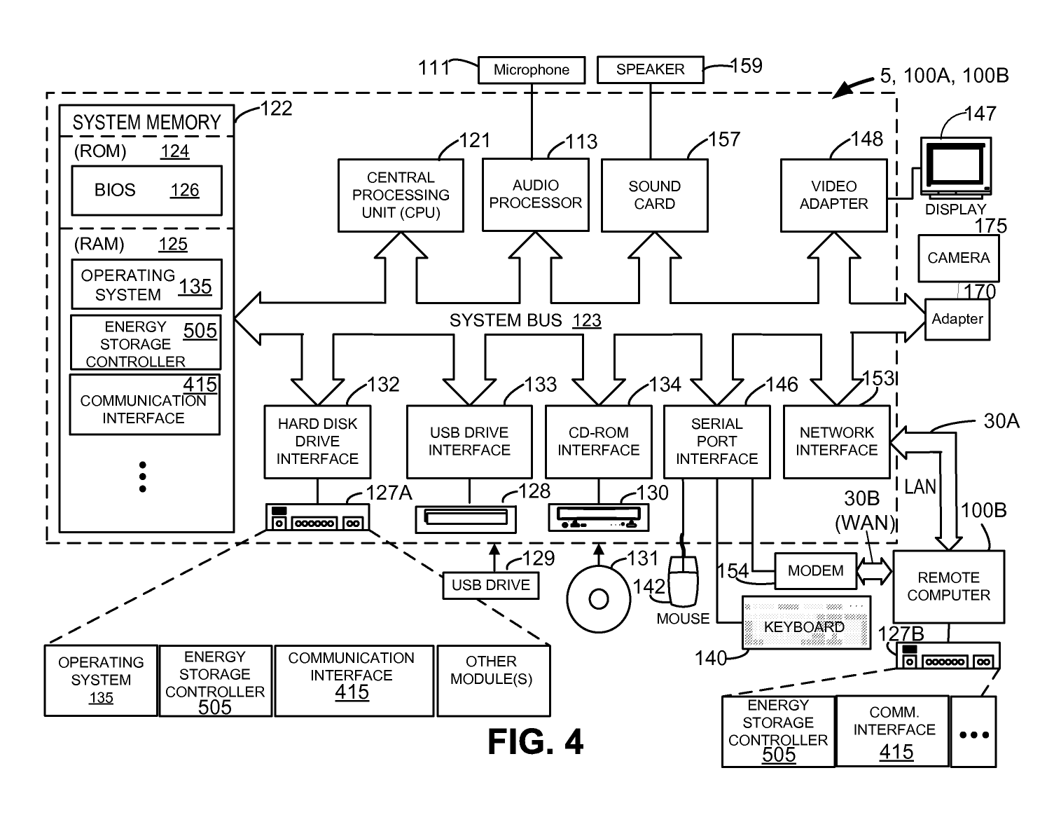

The controller 100A may transmit its commands over the communications network 30 as load control parameters. These exemplary load control parameters as well as the main operation of the energy storage controller 5 that communicates with the central controller 100A will be discussed in further detail below in connection with FIG. 4.

As noted above, the central controller 100A of the utility provider is also coupled to one or more energy sources 77. The one or more energy sources 77 may include, but are not limited to, nuclear power, wind power, solar power, geothermal power, hydroelectric power, and fossil fuelled power plants such as, but not limited to, coal-fired power stations, renewable energy plants or biomass-fuelled power plants, combined cycle plants, internal combustion reciprocating engine power plants, etc.

An energy distribution system 84 may be coupled to the energy sources 77 and a substation 20. The energy distribution system 84 may comprise components for distributing and managing electrical energy. In such an exemplary embodiment, the energy distribution system 84 may comprise a network that carries electricity from a transmission system and delivers it to consumers. Typically, the network would include medium-voltage (less than 50 kV) power lines.

The substation 20 may comprise electrical substations and pole-mounted transformers. The substation 20 may also comprise low-voltage (less than 1 kV) distribution wiring and sometimes electricity meters. The substation may be coupled to the energy distribution system 84 and a transformer 18.

The transformer 18 is coupled to the substation 20 and the energy storage coupler 16. The energy storage coupler 16 may comprise an inverter when the replenishable energy storage device 14 comprises an electrical storage device such as, but not limited to, one or more batteries, one or more capacitors, or any combination thereof. When the replenishable energy source 14 function as a source relative to the energy distribution system 84, then energy source 14 may supply power through the inverter 16 that converts Direct Current (dc) output of the energy source 14 to Alternating Current (ac) used by the energy distribution system 84. The output from the inverter 16 is stepped up via a transformer 18 to match the connection voltage on the substation 20 of the electrical distribution system 84.

A meter 88, such as an electric meter, may be coupled between the transformer 18 and the energy storage coupler (inverter) 16. The meter 88 may be part of an advanced metering infrastructure (AMI) network. The meter 88 may include its own RF circuitry and antenna (not illustrated) for communicating back to the tower 28 and the computer communications network 30. The central controller 100A and/or the personal computing device 1008 may use the meter 88 to monitor the status of the energy storage device's input or output relative to the grid 84. The meter 88 may be capable of supporting rapid reads, such as on the order of approximately one second reads or less (or greater as desired).

The central controller 100A and personal computing device 1008 which are coupled to the communication is network 30 may each comprise a general purpose computer. In general, it is envisioned that the controller 100A will be a dedicated computing system, while the personal computing device 1008 operated by a utility provider is a smaller scaled device, like a personal computer. The personal computing device 1008 may issue commands directly to each customer energy consuming system 22.

Alternatively, the personal computing device 1008 may be operated by a utility provider for issuing commands to the central controller 100A at the utility provider, which in-turn issues commands to each customer energy consuming system 22. In this description, the personal computing device 1008 may include a cellular telephone, a pager, a portable digital assistant (“PDA”), a smartphone, a navigation device, a hand-held computer with a wireless connection or link, a lap-top, a desk top, or any other similar computing device.

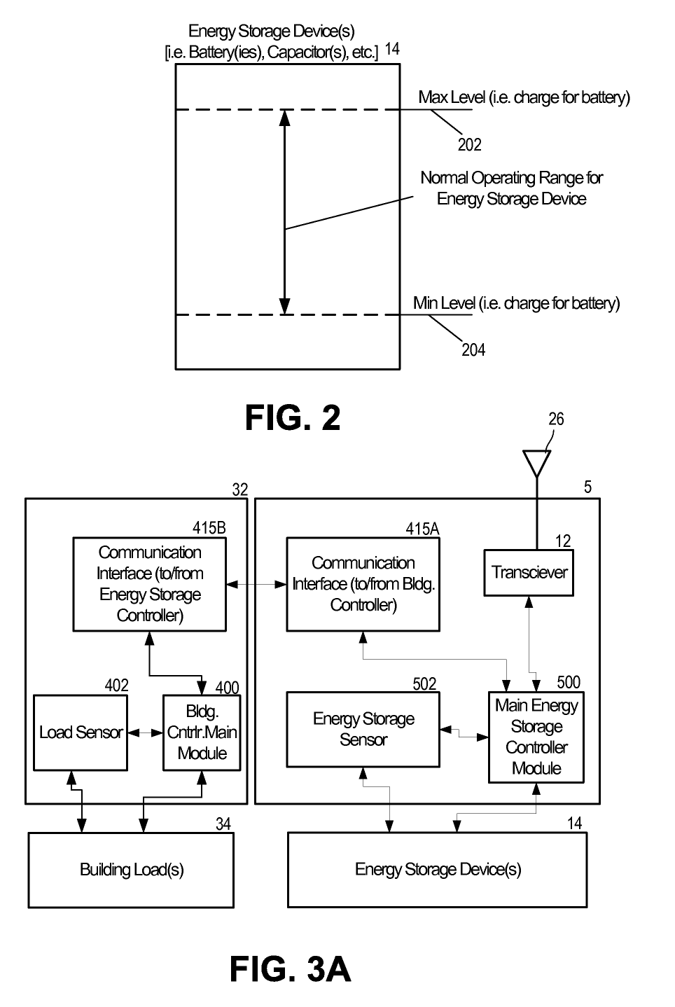

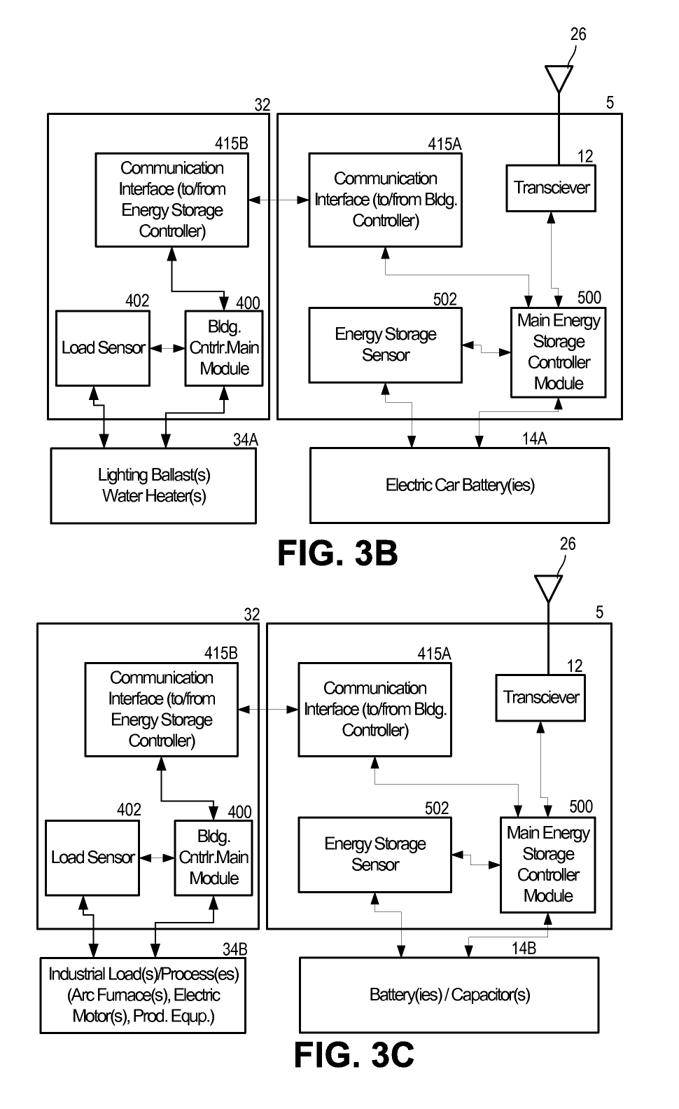

The customer energy consuming system 22 may comprise an antenna 26, an energy storage controller 5, a replenishable energy source 14 that may include an energy storage device, a building load controller 32, and one or more building loads 34. Further details of the replenishable energy source 14 will be described below in connection with FIG. 2. Further details of the energy storage controller 5 and building load controller 32 will be described below in connection with FIGS. 3A-3C.

An International Organization for Standardization (ISO) interface logic module 66 may be coupled and positioned between the antenna 26 and the energy storage controller 5. The ISO interface logic module 66 has been illustrated with dashed lines to indicate that this module 66 is optional. The module 66 may support one or more protocols that include a family of logic languages, based on first-order logic, intended to facilitate the exchange and transmission of knowledge in computer-based systems as understood by one of ordinary skill in the art.

While the elements of the customer energy consuming system 22 have been illustrated as contained within a single rectangular box, one of ordinary skill in the art recognizes that any of these elements may employ various different electronic packaging schemes without departing from the scope of the system 101. That is, for example, energy storage controller 5 may reside in a different physical housing relative to the building load controller 32.

The basic operation of the system 101 is as follows: the controller 100A at the utility provider determines whether it should issue a source control signal or a sinking control signal depending on how the energy sources 77 are operating relative to the present electrical power demand. The controller 100A determines if the energy sources 77 are exceeding the present electrical power demand or if they are falling below the present electrical power demand.

If the energy sources 77 are exceeding the present electrical power demand, then the controller 100A will issue a sinking command so that the replenishable energy source 14 of the customer energy consuming system 22 may receive the excess power being generated by the energy sources 77. If the energy sources 77 are falling below the present electrical power demand, then the controller 100A will issue a source command so that the replenishable energy source 14 of the customer energy consuming system 22 may receive the excess power being generated by the energy sources 77.

The controller 100A will transmit its control signal over the computer communications network 30 to the customer energy consuming system 22 and its corresponding energy storage controller 5. The energy storage controller 5 receives the control signal and determines the present capacity of the replenishable energy source 14 which may comprise an energy storage device. The energy storage controller 5 determines this capacity in view of the control signal that was issued.

This means if a source control signal was issued, then the energy storage controller 5 determines how much energy the replenishable energy source 14 may provide in an upstream manner back to the energy distribution system 84 and energy sources 77. If a sink control signal was issued by the central controller 100A, then the energy storage controller 5 determines how much the replenishable energy source 14 may receive energy in a downstream manner from the energy distribution system 84 and substation 20.

Next, the energy storage controller 5 may request the building load controller 32 to determine the capacity of the building load 34 relative to the capacity of the replenishable energy source 14. Subsequently, the energy storage controller 5 may issue a command to the building load controller 32. This command may instruct the building load controller 32 to operate the building load 34 as either a source or as a sink depending upon the command that the energy storage controller 5 received from the central controller 100A of the utility provider.

If the energy storage controller 5 instructs the building load controller 32 to operate the building load 34 as a sink, then the building load controller 32 will prepare the building load 34 for receiving excess electrical energy from the energy sources 77, energy distribution system 84, and substation 20. If the energy storage controller 5 instructs the building load controller 32 to operate as an energy source, then the building load controller 32 will reduce the building load 34 such that the building load 34 consumes less energy compared to its normal or average operation.

Meanwhile, depending upon the command received from the central controller 100A, the replenishable energy source 14 may also be supplying energy in a source command scenario or it may be receiving excess energy in a sink command scenario. In this way, the replenishable energy source 14 in combination with the building load 34 may increase the energy “size” of the customer energy consuming system 22 relative to the energy sources 77.

FIG. 2 is diagram that illustrates a capacity for an exemplary energy storage device 14 that functions a replenishable energy source. The exemplary energy storage device 14 may comprise any one or a combination of energy storage technologies. According to one exemplary embodiment, the energy storage device 14 may comprise a battery, a capacitor, or any combination thereof.

Exemplary batteries 14 include, but are not limited to, Flow batteries, Vanadium redox batteries, Zinc-bromine flow batteries, Fuel cells, Lead-acid batteries, Deep cycle batteries, VRLA batteries, AGM batteries, Gel batteries, Lithium-ion batteries, Air-fueled lithium-ion batteries, Lithium ion polymer batteries, Lithium iron phosphate batteries, Lithium-sulfur batteries, Lithium-titanate batteries, Molten salt batteries, Nickel-cadmium batteries, Nickel-cadmium batteries vented cell type, Nickel hydrogen batteries, Nickel-iron batteries, Nickel metal hydride batteries, Low self-discharge NiMH batteries, Nickel-zinc batteries, Organic radical batteries, Polymer-based batteries, Polysulfide bromide batteries, Rechargeable alkaline batteries, Sodium-sulfur batteries, Super iron batteries, Zinc-bromine flow batteries, and Zinc matrix batteries, just to name a few.

The energy storage device 14 may comprise one or more batteries and/or capacitors of an electric vehicle, such as an electric car. When the electric vehicle is being charged while it is coupled to an A/C outlet, then this A/C outlet may be monitored and controlled by an energy storage controller 5 according to an exemplary embodiment.

FIG. 2 illustrates the energy storage device 14 with an upper limit 202 and a lower limit 204 for an operating range of the device. Usually, it is desirable to operate the energy storage device 14 within these bounds or limits 202, 204 in order to maximize the performance and the operating life of the device, such as in the case of a battery used as the energy storage device 14. An exemplary upper limit 202 may comprise a magnitude of approximately 90% of full storage for the device 14 and an exemplary lower limit 204 may comprise a magnitude of approximately 20% of full storage for the device 14.

For exemplary replenishable energy sources or storage technologies, like batteries, the upper and lower limits 202, 204 may be dependent on the physics of the device 14, such as on battery chemistry. In some cases, these limits may be important for specific types, such as on the discharge side for lithium ion type batteries. In a battery or capacitor exemplary embodiment, these limits 202, 204 may have values defining a charge in voltage and/or current. Exemplary batteries may comprise operating ranges rated in megawatt (mW) hours (mW/hr). When the energy storage device 14 comprises the battery of an electric vehicle, such as an electric car, the battery may have an operating range of between approximately twenty to approximately 50 kiloWatt hours (kW-hr).

As noted previously, the energy storage device 14 is not limited to batteries and/or capacitors. The energy storage device 14 may also include mechanical energy storage devices as understood by one of ordinary skill the art. For example, the energy storage device 14 may comprise a flywheel housed within an evaporated or vacuum chamber.

From the perspective of the grid requirements for frequency regulation, the energy storage device 14 may provide useful support when it is operating between the upper and lower limits 202, 204. The principle described in this disclosure is the use of building loads 34 to extend this range between the upper and lower limits 202, 204 by taking coordinated action which has the effect of making the energy storage device 14 appear to the grid 84 as a much larger resource.

This concept of the energy storage device 14 appearing to the grid 84 as a much larger resource is illustrated and has been described above in connection with FIG. 1. For a building load 34 of a building that is on (and consuming electrical energy), turning that load 34 off or reducing this load 34 is equivalent, from the grid perspective, to discharging an energy storage device 14 into the grid since less energy is used by the building load 34. Similarly, for a building load 34 of a building that is on (and consuming electrical energy), increasing the load 34 is equivalent, from the grid perspective, to receiving excess energy and functioning as an energy sink.

Referring now to FIG. 3A, this figure is a diagram illustrating exemplary details of an energy storage controller 5, a building load controller 32, an energy storage device 14, and building loads 34 illustrated in FIG. 1. The energy storage controller 5 may comprise a transceiver 12, and antenna 26, a communication interface 415A, and energy storage sensor 502, and a main energy storage controller 500.

The transceiver 12 may comprise a communication unit such as a modem, a network card, or any other type of coder/decoder (CODEC) for receiving and sending load control signals to and from the communications network 30. In a wireless embodiment, the transceiver 12 may further comprise a radiofrequency circuit for generating radiofrequency communication signals which utilize the antenna 26 and that establish the wireless communications link 103B with the communication network 30. In other embodiments, the transceiver 12 may be coupled to the communications network 30 by a direct wired communications link 103C.

The main energy storage controller module 500 may comprise hardware or software or a combination thereof. The hardware may comprise a microprocessor running various types of software. The hardware may include electronics, such as application specific integrated circuits (ASICs) and the like.

The main energy storage controller module 500 they be coupled to the transceiver 12, the energy storage sensor 502, and the communication interface module 415A. The energy storage sensor 502 may comprise hardware and/or software for monitoring the energy conditions of the energy storage device 14. The energy storage sensor 502 may determine how much energy the energy storage device 14 may receive or how much energy the energy storage device 14 may release or discharge. The energy storage sensor 14 may comprise a current detector or a voltage detector (or both) in those exemplary embodiments in which the energy storage device 14 comprises a battery, a capacitor, or any combination thereof.

The communication interface module 415A may also comprise hardware and/or software that supports communications between the main energy storage controller module 500 and the building controller main module 400. The communication interface module 415A may support one or more various communication protocols if the building controller main module 400 in the main energy storage controller module 500 use different types of communication protocols.

The building load controller 32 may comprise a communication interface module 415B, a load sensor 402, and the building controller main module 400. The communication interface module 415B is coupled to the communication interface module 415A of the energy storage controller 5. The communication interface module 415B may operate and function similarly to the communication interface module 415A.

The building controller main module 400 receives and transmits communications via the communication interface module 415B to the main energy storage controller module 500. The building controller main module 400 also communicates with the load sensor 402 in order to determine the current loading conditions of the building loads 34. The building controller main module 400 may comprise a switch described in U.S. Pat. No. 5,462,225 issued in the name of Massara et al., the entire contents of which are hereby incorporated by reference. The switch within the building main module 400 may be designed to control power supplied to one or more building loads 34, which may include, but or not limited to, HVAC equipment such as air conditioners and furnaces.

The building controller main module 400 may comprise one or more timers: one for tracking load shed time; one for tracking load restore time. The building controller main module 400 may be part of the device known as a digital control unit (DCU) manufactured by Comverge, Inc. A DCU may be designed to be coupled outside of a dwelling near one or more parts of an HVAC system, such as near the compressor of an air-conditioning unit. The DCU may be used for communication through various channels including through wide area and local area networks 30. Another example of the building controller main module 400 is a computational device like a computer or dedicated processing unit that is coupled to the space conditioning load 24.

The building controller main module 400 as well as the main energy storage controller module 500 may each be coupled to a memory. Each memory may comprise a volatile component or a non-volatile component, or a combination thereof. The non-volatile component may comprise read only memory (ROM). The ROM may store the operating system (OS) for the building main controller 400 and energy storage controller module 500 which may be executed by a central processing unit and/or firmware of each module as understood by one of ordinary skill in the art.

The volatile component for each memory of the customer energy consuming system 22 may comprise random access memory (RAM). The volatile memory component for the customer energy consuming system 22 may incorporate other different memory technologies, such as, but not limited to, erasable programmable read-only memory (EPROM) or electrically erasable programmable read-only memory (EEPROM), and/or flash memory and ferroelectric random access memory (FRAM).

Each memory, whether volatile or non-volatile, for the building controller main module 400 or the main energy storage controller module 500 may store the instructions corresponding to the method illustrated in FIG. 4 described below. The memory may also record energy levels detected by the load sensor 402 and the energy storage sensor 502. Other data that may be stored in memory, may include, but is not limited to, actions taken by either the building controller main module 400 and/or the main energy storage controller 500, data generated by thermostats, such as times between “on” and “off” cycles of a compressor or HVAC unit, load control parameters transmitted by the controller 100A at the utility provider, and commands issued by the personal computing device 1008 coupled to the communications network 30.

The building load 34 may comprise a devices which may consume energy and which may be adjusted to operate at a reduced rate in order to lower the amount of energy that a particular device may consume. For example, a building load may comprise a heating, ventilating, air-conditioning (HVAC) system as understood by one of ordinary skill in the art which can be “cycled-off” in order to reduce its energy consumption. When HVAC systems form the building load 34, then any climate controlled spaces coupled to the HVAC system may be considered as part of the building load 34. The climate controlled space may comprise a single room or a plurality of rooms that are form a “zone” as understood by one of ordinary skill in the art. The climate controlled space may comprise any type of room or volume which is fully closed off or partially closed off relative to the outside. As noted above, the climate controlled space may comprise a single room or a plurality of rooms joined together by an air ventilation system.

If an HVAC system includes an air-conditioning system, the building controller main module 400 may cycle “on” and “off” the electrical power to the compressor of the space conditioning load 24. If HVAC system includes a forced air heating system or a heat pump, the building controller main module 400 may control power to either the fan of a furnace or the compressor of a heat pump.

The building load may 34 comprise a digital lighting ballast or an electric water heater. Both of these devices may receive excess electrical energy when the building load 34 is required to operate as an energy sink. For the digital lighting ballast, this means that it can operate it lights to run brighter when the digital lighting ballast is intended to consume excess electrical energy. For a water heater, this means that the device may receive extra current for heating its water to a higher temperature and/or heating its water for a longer period of time. When the digital lighting ballast is intended to reduce its consumption so that it functions as an energy source, the lighting ballast may dim lights under its control in order to utilize less electrical energy.

The building load 34 may comprise one or more industrial loads and/or processes. For example, the building load may comprise an arc furnace in an industrial setting. Similarly, the building load 34 may comprise one or more industrial electric motors and industrial production equipment.

The building load 34 is not limited to the exemplary embodiments described above. The building load may comprise a single device or a combination of any of the devices described above.

FIG. 3B is a diagram illustrating exemplary details of an energy storage controller 5, a building load controller 32, an energy storage device 14A, and building loads 34A illustrated in FIG. 1 according to one exemplary embodiment. FIG. 3B is similar to FIG. 3A. Therefore, only the differences between these 2 figures will be described below.

According to this exemplary embodiment, the energy storage device 14 may comprise one or more electric car batteries. The customer energy consuming system 22 may comprise a single family home, a plurality of homes such as a townhome segment or an apartment complex, or the system 22 may comprise a parking garage. The one or more building loads 34 may comprise digital lighting ballasts as well as electric water heaters.

The main energy storage controller module 500 may work in tandem with the building controller main module 400 in order to increase the relative size of the electric car batteries 14A from the perspective of the energy sources 77 and energy distribution system 84. This exemplary embodiment may be characterized as the “residential” type of customer energy consuming system 22.

FIG. 3C is a diagram illustrating exemplary details of an energy storage controller 5, a building load controller 32, an energy storage device 14B, and building loads 34B illustrated in FIG. 1 according to one exemplary embodiment. FIG. 3C is similar to FIG. 3A. Therefore, only the differences between these 2 figures will be described below.

According to this exemplary embodiment, the energy storage device 14B may comprise one or more batteries and/or capacitors. The building load 34B may comprise one or more industrial loads and/or processes. The industrial loads may include, but are not limited to, arc furnaces, electric motors, variable frequency drive motors that can change power on command, and other types of production equipment.

The main energy storage controller module 500 may work in tandem with the building controller main module 400 in order to increase the relative size of the batteries and/or capacitors 14B from the perspective of the energy sources 77 and energy distribution system 84. This exemplary embodiment may be characterized as the “industrial” type of customer energy consuming system 22.

FIG. 4 is a diagram of the main components for an exemplary energy storage controller 5 illustrated in FIG. 1. The exemplary operating environment for the energy storage controller 5 may include a general-purpose computing device in the form of a conventional computer. In other cases, the controller 5 may comprise a dedicated unit with function specific hardware and/or software.

Generally, a computer forming the energy storage controller 5 includes a central processing unit 121, a system memory 122, and a system bus 123 that couples various system components including the system memory 122 to the processing unit 121.

The system bus 123 may be any of several types of bus structures including a memory bus or memory controller, a peripheral bus, and a local bus using any of a variety of bus architectures. The system memory includes a read-only memory (“ROM”) 124 and a random access memory (“RAM”) 125. A basic input/output system (“BIOS”) 126, containing the basic routines that help to transfer information between elements within computer, such as during start-up, is stored in ROM 124.

The computer 100A may include a hard disk drive 127A for reading from and writing to a hard disk, not shown, a USB port 128 for reading from or writing to a removable USB drive 129, and an optical disk drive 130 for reading from or writing to a removable optical disk 131 such as a CD-ROM, a DVD, or other optical media. Hard disk drive 127A, USB drive 129, and optical disk drive 130 are connected to system bus 123 by a hard disk drive interface 132, a USB drive interface 133, and an optical disk drive interface 134, respectively.

Although the exemplary environment described herein employs hard disk 127A, removable USB drive 129, and removable optical disk 131, it should be appreciated by one of ordinary skill in the art that other types of computer readable media which can store data that is accessible by a computer, such as magnetic cassettes, flash memory cards, digital video disks, Bernoulli cartridges, RAMs, ROMs, and the like, may also be used in the exemplary operating environment without departing from the scope of the system 101. Such uses of other forms of computer readable media besides the hardware illustrated will be used in internet connected devices.

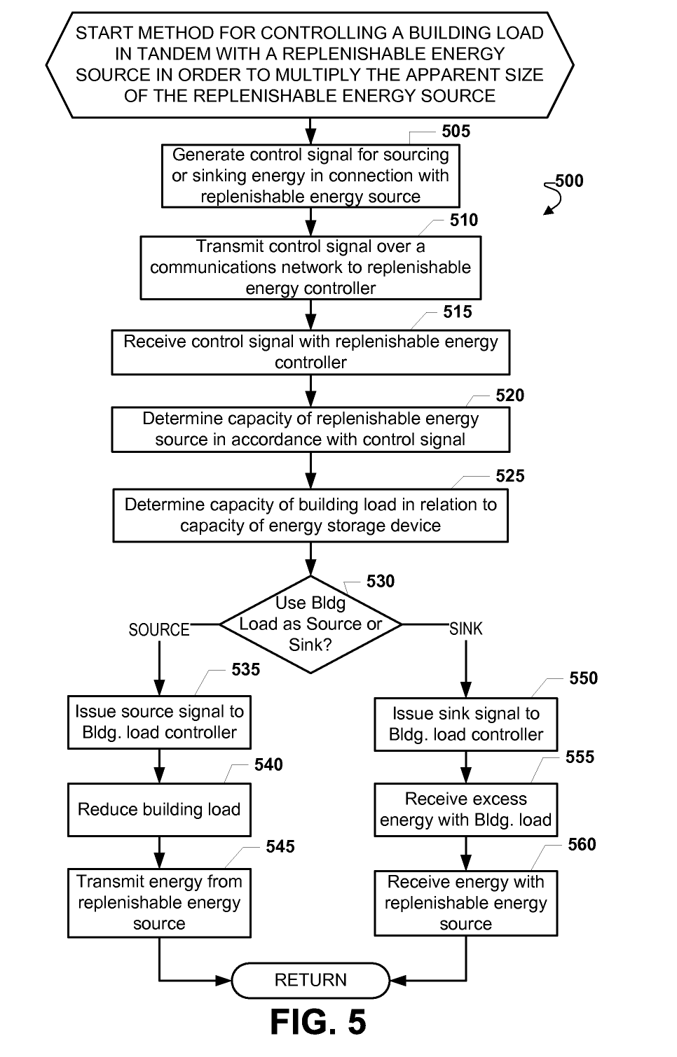

The drives and their associated computer readable media illustrated in FIG. 1B provide nonvolatile storage of computer-executable instructions, data structures, program modules, and other data for computer or client device 100A. A number of program modules may be stored on hard disk 127, USB drive 129, optical disk 131, ROM 124, or RAM 125, including, but not limited to, an operating system 135, main energy storage controller module 505, and a communication interface 415. Details about the main energy storage controller module 505 and its operation will be described below in connection with FIG. 5. Each program module may include routines, sub-routines, programs, objects, components, data structures, etc., which perform particular tasks or implement particular abstract data types.

A user may enter commands and information into the computer through input devices, such as a keyboard 140 and a pointing device 142. Pointing devices may include a mouse, a trackball, and an electronic pen that can be used in conjunction with an electronic tablet. Other input devices (not shown) may include a joystick, game pad, satellite dish, scanner, or the like. These and other input devices are often connected to processing unit 121 through a serial port interface 146 that is coupled to the system bus 123, but may be connected by other interfaces, such as a parallel port, game port, a universal serial bus (USB), or the like.

The display 147 may also be connected to system bus 123 via an interface, such as a video adapter 148. As noted above, the display 147 can comprise any type of display devices such as a liquid crystal display (LCD), a plasma display, an organic light-emitting diode (OLED) display, and a cathode ray tube (CRT) display.

A camera 175 may also be connected to system bus 123 via an interface, such as an adapter 170. The camera 175 may comprise a video camera. The camera 175 can be a CCD (charge-coupled device) camera or a CMOS (complementary metal-oxide-semiconductor) camera. In addition to the monitor 147 and camera 175, the client device 100A, comprising a computer, may include other peripheral output devices (not shown), such as a printer.

The computer may also include a microphone 111 that is coupled to the system bus 123 via an audio processor 113 is understood by one of ordinary skill in the art. A microphone 111 may be used in combination with a voice recognition module (not illustrated) in order to process audible commands received from an operator. A speaker 159 may be provided which is coupled to a soundcard 157. The soundcard 157 may be coupled to the system bus 123.

The computer forming the energy storage controller 5 may operate in a networked environment using logical connections to one or more remote computers, such as a web server. A remote computer 100B may be another personal computer, a server, a mobile phone, a router, a networked PC, a peer device, or other common network node. While the web server or a remote computer 100B typically includes many or all of the elements described above relative to energy storage controller 5, only a memory storage device 127B has been illustrated in this FIG. 4. The logical connections depicted in FIG. 4 include a local area network (LAN) 30A and a wide area network (WAN) 30B. Such networking environments are commonplace in offices, enterprise-wide computer networks, intranets, and the Internet.

When used in a LAN networking environment, the computer forming the energy storage controller 5 is often connected to the local area network 30A through a network interface or adapter 153. When used in a WAN networking environment, the computer typically includes a modem 154 or other means for establishing communications over WAN 30B, such as the Internet. Modem 154, which may be internal or external, is connected to system bus 123 via serial port interface 146. In a networked environment, program modules depicted relative to the remote computer 100B, or portions thereof, may be stored in the remote memory storage device 127A. It will be appreciated that the network connections shown are exemplary and other means of establishing a communications link between the computers may be used.

Moreover, those skilled in the art will appreciate that the system 101 may be implemented in other computer system configurations, including hand-held devices, multiprocessor systems, microprocessor based or programmable consumer electronics, network personal computers, minicomputers, mainframe computers, and the like. The system 101 may also be practiced in distributed computing environments, where tasks are performed by remote processing devices that are linked through a communications network. In a distributed computing environment, program modules may be located in both local and remote memory storage devices.

FIG. 5 is a flowchart illustrating a method 500 for controlling a building load 34 in tandem with a replenishable energy source 14 in order to multiply or increase the apparent size of the replenishable energy source 14. Step 505 is the first step of the method 500. In step 505, the controller 100A at the utility provider determines if the present load of its energy system is exceeding the system's energy generation or if its energy generation is falling below the present load of the energy system. In an electrical energy context, the utility provider in step 505 may determine if the present electrical load has exceeded the present power generation or if the present power generation is exceeding the present electrical load.

If the present electrical load is exceeding the present power generation, then the controller 100A may generate a source control signal that requests energy to be provided by the replenishable energy source 14 and/or energy curtailed by one or more building loads 34. If the present power generation is exceeding the present electrical load, then the controller 100A may generate a sink signal that requests excess electrical energy to be received by the replenishable energy source 14 and/or building loads 34 of each customer energy consuming system 22.

The source and sink signals from the controller 100A may comprise specific magnitudes of energy requirements as well as duration or time periods for each customer energy consuming system 22. As a non-limiting example, the source and sink signals may be updated at about four second intervals for both magnitude and direction.

Next, in step 510, the controller 100A may transmit its control signal(s) over the communications network 30 to the energy storage controller 5 of each customer energy consuming system 22. Next, in step 515, the energy storage controller 5 may receive the control signal from the controller 100A. The energy storage controller 5 may store the control signal in a storage device, like memory, that may include volatile or nonvolatile memory types.

In step 520, the energy storage controller 5 may determine the capacity of the energy storage device 14 relative to what is requested in the control signal. The energy storage controller 5 may work with the energy storage sensor 502 in order to measure this capacity of the energy storage device 14. For example if the control signal is one that requests the energy storage device 14 to function as a sink, then the energy storage controller 5 working with the energy storage sensor 502 may determine the capacity of the energy storage device 14 to receive surplus or excess energy from the energy sources 77 and energy distribution system 84.

If the control signal from the central controller 100A is one that requests the energy storage device 14 to function as a source, then the energy storage controller 5 in step 520 may work with the energy storage sensor 502 to determine the capacity of the energy storage device 14 to provide additional energy into the energy distribution system 84 in an upstream manner towards the energy sources 77. The control signal may comprise a specific magnitude of energy that it requests the energy storage device 14 to provide or to receive from the energy distribution system 84 and/or energy sources 77. For example, the control signal may comprise a specific amount of energy that the power grid needs to send to or requires from the replenishable energy source 14. The control signal may also indicate a duration of time for the replenishable energy source 14 to receive and/or transmit this energy. The magnitude and direction of the control signal may be updated periodically, on the order of seconds to milliseconds.

Next, in step 525 the main energy storage controller module 500 may request the building controller main module 400 to determine the capacity of the building load 34 in relation to the capacity of the energy storage device 525. In other words, depending upon the type of control signal received by the main energy storage controller 500 (a sink signal or source signal), the building controller main module 400 may determine how the building load 34 may amplify the impact of the energy storage device 14.

In some cases or scenarios, it is possible that the energy storage device 14 by itself or alone may satisfy the request from the control signal issued by the central controller 100A. In such cases, step 525 may be skipped in which the main energy storage controller 500 does not issue any requests to the building controller main module 400.

However, for those cases or situations in which the energy storage device 14 may not completely satisfied the energy requests of the control signal from the central controller 100A, the main energy storage controller module 500 will issue its request to the building controller main module 400. In this step 525, the building controller main module 400 may work with the load sensor 402 in order to determine the capacity for excess energy reception or energy load shedding that may be available from the building load 34.

Next, in decision step 530, the main energy storage controller module 500 determines how it will use the energy storage device 14 in tandem with the building load 34 in order to address the request from the control signal issued by the central controller 100A. Decision step 530 may be dependent upon the operating range of the energy storage device 14. If the inquiry to decision step 530 is that the control signal has issued a source command to the main energy storage controller module 500 and the energy storage device 14 is likely to reach its minimum capacity 202, then the “SOURCE” branch is followed to block 535 in which the main energy storage controller module 500 issues a source signal to the building controller main module 400.

Alternatively, in decision step 530, the main energy storage controller module 500 may determine to use the building load 34 to reduce charging and discharging cycles on the energy storage device 14, especially if the energy storage device in an exemplary embodiment comprises an electrical battery. Such reduction in charging and discharging cycles may extend life for some battery chemistries as understood by one of ordinary skill in the art. The main energy storage controller module 500 would issue a “source” command or a “sink” command to the building controller main module 400 depending upon the state of the replenishable energy source/energy storage device 14.

In step 540 (after step 535 if a “source” command was issued in decision Step 530), the building controller main module 400 reduces the building load 34. The building load 34 may be reduced by using one or more load shedding techniques such that the building load 34 is significantly reduced so that the building load 34 appears to the energy distribution system 84 and energy sources 77 as a “SOURCE” of energy. Next, in step 545, the main energy storage controller 500 may issue a command to the energy storage device 14 to release energy into the energy distribution system 84 in an upstream manner through the energy storage coupler 16 (such as inverter) and through the transformer 18 and substation 20. Step 545 may occur prior to and in the absence of steps 535 and 540 if the energy storage device 14 is operating within its maximum and minimum limits 202, 204.

If the inquiry to decision step 530 is that the command signal from the central controller 100A comprises a “SINK” signal and the energy storage device 14 is likely to reach its maximum capacity 202, then the main energy storage controller module 500 may issue a “SINK” signal to the building controller main module 400. The building controller main module 400 may then issue a command in step 555 to the building load 34 to receive excess energy. For example, the building controller main module 400 may issue a command to a digital ballast operating as the building load 34 such that the digital ballast receives excess energy by operating its lights at a higher frequency which would cause such lights to brighten and consume the additional energy requested by the control signal from the central controller 100A.

Next, in step 560, the main energy storage controller module 500 may instruct the energy storage device 14 to receive excess or surplus energy from the energy storage coupler 16 so that the energy sources 77 and energy distribution system 84 may distribute this excess energy into the energy storage device 14. Step 560 may occur prior to and in the absence of steps 535 and 540 if the energy storage device 14 is operating within its maximum and minimum limits 202, 204. The method 500 then returns to step 505.

Exemplary Scenarios:

Assume that the size of the energy storage device 14, such as a battery, for frequency response, is defined as the ability to: (A) Follow a four second control signal from the central controller 10 and either charge or discharge as commanded by the signal from the energy storage controller 5; and (B) sustain a single state either charge or discharge for approximately fifteen minutes.

Assume that the battery 14 in question is capable of supplying approximately one MW for approximately fifteen minutes (which equates to approximately 0.25 MW/hr) when the battery 14 is discharged from the midpoint between the max charge level 202 and the min charge level 204 as illustrated in FIG. 2. Also, assume that the battery 14 requires approximately one MW for approximately fifteen minutes (which equates to approximately 0.25 MW/hr) in the charge mode to go from the midpoint to the max charge level 202. Given this operating range, the battery 14 may be rated at approximately one MW by the grid operator for frequency response purposes.

If the building had a load 34 that could be varied on demand by operating in a shed power mode in response to a command from the building load controller 32 (or building controller main module 400), it could be used to increase the effective size of the battery resource 14. If the building load 34 in question were lighting ballasts that were digitally controllable to either use more energy (i.e. brighter) or less energy (i.e. dimmer), then the energy storage controller 5 could utilize this load 34 in conjunction with the battery 14 to extend the apparent size of the battery 14 from the perspective of the energy sources 77 and energy distribution system 84.

If the lighting load 34 could be operated by the building load controller 32 to use an approximately additional MW of power for an extended period of time or shed approximately a MW of power for an extended period of time, then the combined battery/building combination would appear as twice as large to the grid operator 12 relative to the battery 14 alone.

The customer energy consuming system 22 could start responding to a discharge command from the central controller 100A by supplying power from the battery 14. As the battery 14 approaches the min level limit 204 as illustrated in FIG. 2, the energy storage controller 5 could request the building controller 32 (or building controller main module 400) to dim and use approximately one MW less than normal thus extending the length of time that the battery/building system 22 could remain in the discharge mode.

A similar scenario would occur in the opposite direction for a lengthy system request for the battery 14 to charge or sink power from the grid 22 via the substation 20. In this case, on commands originating from the energy storage controller 5 sent to the building controller 32, the lighting system load 34 may brighten and use more energy for the required period of time in order to expend the surplus or additional energy supplied from the energy sources 77 and the energy distribution system 84.

It is not necessary for a building load 34, like controllable lighting to provide both source (dimming in the case of lighting) and sinking (brightening in the lighting case). This functionality could be shared by multiple loads 34, different or similar loads 34 of the building 30. For example, water heating could be used to selectively sink power as a variable load 34. Also Heating, Ventilation and Air Conditioning (HVAC) is a load 34 that could be used for sourcing or sinking given the proper design.

The word “exemplary” is used in this description to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Further, certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a tangible computer-readable medium. Computer-readable media include both tangible computer storage media and tangible communication media including any tangible medium that facilitates transfer of a computer program from one place to another. A tangible computer storage media may be any available tangible media that may be accessed by a computer. By way of example, and not limitation, such tangible computer-readable media may comprise RAM, ROM, EEPROM, CD-ROM or other optical disk storage, magnetic disk storage or other magnetic storage devices, or any other tangible medium that may be used to carry or store desired program code in the form of instructions or data structures and that may be accessed by a computer.

Also, any connection is properly termed a tangible computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, and DSL are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method for controlling a building load in tandem with a replenishable energy source, the method comprising:
producing a control signal comprising at least one of a source command and a sink command;
transmitting the control signal over a communications network;
determining a capacity of the replenishable energy source in response to the control signal;
determining a capacity of the building load in relation to the replenishable energy source; and
using the building load as one of a source for supplying energy and a sink for receiving energy in response to the control signal.

2. The method of claim 1, further comprising using the replenishable energy source as a source for supplying energy in response to a source command signal, the replenishable energy source supplying electrical energy to an electrical energy distribution system.

3. The method of claim 1, further comprising using the replenishable energy source as a sink for receiving energy in response to a source command signal, the replenishable energy source receiving electrical energy from an electrical energy distribution system.

4. The method of claim 1, wherein the replenishable energy source comprises at least one of a battery, a capacitor, and a combination of a battery and a capacitor.

5. The method of claim 1, wherein the building load comprises at least one of a digital lighting ballast; heating, ventilating, air-conditioning (HVAC) equipment; a water heater; an arc furnace; an electric motor; and a piece of industrial production equipment.

6. The method of claim 1, wherein using the building load as a source for supplying energy comprises applying a load shedding technique to the building load in which the building load operates at a reduced rate.

7. The method of claim 1, wherein using the building load as a sink for receiving energy comprises operating the building load at a higher rate for consuming more energy relative to a normal state.

8. The method of claim 1, wherein the replenishable energy source comprises a battery of an electric vehicle.

9. The method of claim 8, wherein the electric vehicle comprises at least one of an automobile, a motorcycle, and a truck.

10. The method of claim 1, further comprising using the building load to reduce a number of charge and discharge events for the replenishable energy source.

11. A system for controlling a building load in tandem with a replenishable energy source, the system comprising:
means for producing a control signal comprising at least one of a source command and a sink command;
means for transmitting the control signal over a communications network;
means for determining a capacity of the replenishable energy source in response to the control signal;
means for determining a capacity of the building load in relation to the replenishable energy source; and
means for using the building load as one of a source for supplying energy and a sink for receiving energy in response to the control signal.

12. The system of claim 1, further comprising means for using the replenishable energy source as a source for supplying energy in response to a source command signal, the replenishable energy source supplying electrical energy to an electrical energy distribution system.

13. The system of claim 1, further comprising means for using the replenishable energy source as a sink for receiving energy in response to a source command signal, the replenishable energy source receiving electrical energy from an electrical energy distribution system.

14. The system of claim 1, wherein the replenishable energy source comprises at least one of a battery, a capacitor, and a combination of a battery and a capacitor.

15. The system of claim 1, wherein the building load comprises at least one of a digital lighting ballast; heating, ventilating, air-conditioning (HVAC) equipment; a water heater; an arc furnace; an electric motor; and a piece of industrial production equipment.

16. The system of claim 1, wherein the means for using the building load as a source for supplying energy comprises means for applying a load shedding technique to the building load in which the building load operates at a reduced rate.

17. A system for controlling a building load in tandem with a replenishable energy source comprising:
a central controller for producing a control signal comprising at least one of a source command and a sink command;
a communications network for receiving and relaying the control signal;
an energy storage controller coupled to the communications network for determining a capacity of a replenishable energy source in response to the control signal, the energy storage controller generating commands to cause the building load to be used as one of a source for supplying energy and a sink for receiving energy in response to the control signal.

18. The system of claim 17, further comprising a building controller that determines a capacity of the building load in relation to the replenishable energy source.

19. The system of claim 17, wherein the replenishable energy source comprises at least one of a battery, a capacitor, and a combination of a battery and a capacitor.

20. The system of claim 17, wherein the building load comprises at least one of a digital lighting ballast; heating, ventilating, air-conditioning (HVAC) equipment; a water heater; an arc furnace; an electric motor; and a piece of industrial production equipment.
